(19) United States
(12) Patent Application Publication
(10) Pub. No.: US 2013/0096695 A1
(43) Pub. Date: Apr. 18, 2013

(54) METHOD FOR CONFIGURING A CONTROL DEVICE

(71) Applicant: ABB AG, Manheim (DE)

(72) Inventor: Christian MEYER, Laatzen (DE)

(73) Assignee: ABB AG, Mannheim (DE)

(21) Appl. No.: 13/647,410

(22) Filed: Oct. 9, 2012

(30) Foreign Application Priority Data
Oct. 13, 2011 (DE) 10 2011 115 809.3

(51) Int. Cl. G05B 19/04

(52) U.S. Cl. 700/2

(57) ABSTRACT

A method for configuring a control device for integration of intelligent electrical field devices into a control or automation system having a flexibly expandable hardware structure is disclosed. A configuration of the system is created by a device configuration tool and a system configuration tool. Device configuration data is produced in the device configuration tool from a configuration device description and from a system configuration description provided by the system configuration tool. Project-specific libraries of the logical node types for the user-programmable controller can be created by a logical node type editor. A controller configuration tool can select for the created project-specific libraries to produce device-specific configuration descriptions.

### RELATED APPLICATION(S)

This application claims priority under 35 U.S.C. §119 to German Patent Application No. 10 2011 115 809.3 filed in Germany on Oct. 13, 2011, the entire content of which is hereby incorporated by reference in its entirety.

### FIELD

This disclosure relates to a method for configuring a user-programmable control device for the integration of intelligent field devices into a control or automation system having a flexibly expandable hardware structure. This disclosure also relates to an arrangement for performing the method. This disclosure is used, for example, in process automation or machine control for controlling processes and/or installation components.

### BACKGROUND INFORMATION

Automation systems for controlling a technical process or a technical installation usually comprise a control device (PLC) which is integrated in a complex comprising a multiplicity of intelligent electrical devices, also called intelligent electronic devices (IED). Intelligent electronic devices are microprocessor-based devices, such as protective and control devices, motor protection switches, intelligent switches and voltage regulators, frequency converters, pressure and temperature measuring transducers and flow meters.

The communication between the control device and the intelligent electrical devices (IED) can be performed using a communications protocol, for example, using the communications standard IEC 61850, and is described in EP 1 976 281 A1, for example. For the purpose of data interchange within the system, the devices (IEDs) are configured using a programming tool or programming device, also called an engineering tool, which incorporates the devices into the communications network which operates in accordance with the IEC 61850 standard.

In order to exchange information between the devices which form the control or automation system, for example, to interchange data between functions which are implemented in the devices, the communications nodes are considered as the smallest part of a function which interchanges data with other functions. These logical nodes perform partial functions for the overall function and may be implemented individually or together in devices.

The IEC 61850 communications standard defines, for the intelligent electrical devices, the mapping of the data to be communicated as communications nodes, also called logical nodes, with a previously defined structure, since an IED type, also designated as logical node type, is created specifically for one application type.

User-programmable controllers, for example, the AC500 from ABB, can be used for different areas of application; however, in accordance with the communications standard IEC 61850, different logical node types are needed for the respective areas of application.

For example, in accordance with the IEC 61850 standard, the configuration is created by means of a device configuration tool, also called IED configurator, and a system configuration tool, also called system configurator.

The system configuration, also designated as system specification description (SSD), is stored in the system configurator. The data interchange from the system configurator to the IED configurator, in accordance with the IEC 61850 standard, is defined in the system specification description.

The device configuration data are produced in the IED configurator from a provided configuration device description, also called configured IED description (CID), and the system configuration description (SCD) provided by the system configurator, and are transmitted from the IED configurator to the IED devices in accordance with the IEC 61850 standard.

The device configuration descriptions of the IED devices, also called IED capability description (ICD), contain the respective configuration of the devices provided in the control system. They are included for the relevant field devices on a storage medium by the device manufacturers as a program and are provided for the system configurator for processing. Together with the substation configuration description (SCD) stored in the system configurator, they allow the creation of the configuration for each device provided in the system. The device-specific configuration files thus created, which contain the respective configuration of the devices provided in the control system, are then incorporated into devices of the control or automation system.

For example, connection of flexibly configurable devices to the communications network, which operates in accordance with the IEC 61850 standard, and configuration of the former using the programming tool on the configuration PC are associated with what can be a considerable outlay in terms of configuration, since, given the large number of different application profiles and the optional parts contained therein, many points in the configuration are to be adapted.

### SUMMARY

A method is disclosed for configuring a user-programmable control device for integration of an intelligent electrical field device into a control or automation system having a flexibly expandable hardware structure which comprises: storing a system specification description on a system configuration tool, wherein the system specification description defines a data interchange from the system configuration tool to a device configuration tool in accordance with a defined communications protocol; providing a configuration device description, which defines the data interchange from the device configuration tool to an intelligent electrical field device in accordance with a defined communications protocol for the device configuration tool; producing device configuration data in the device configuration tool from the configuration device description and a system configuration description provided by the system configuration tool; creating project-specific libraries of logical node types for the user-programmable control device using an editing program which is implemented as a logical node type editor; selecting a previously created library using a controller configuration tool; and producing a device-specific configuration descriptions for the control or automation system, which form a prescribed set of logical node types for the control or automation system and which are provided for further processing.

A method is disclosed for configuring a user-programmable control device for integration of an intelligent electrical field device (IED) into a control or automation system having a flexibly expandable hardware structure which comprises: creating a configuration of the control or automation system using a device configuration tool and a system configuration tool; storing a system specification description (SSD) on the system configuration tool, which defines the data interchange from the system configuration tool to the device configuration tool in accordance with a defined communications protocol; providing a configuration device description (CID) for the device configuration tool, which defines data interchange from the device configuration tool to an electrical field device (IED) in accordance with a defined communications protocol; producing device configuration data in the device configuration tool from the configuration device description (CID) and a system configuration description (SCD) provided by the system configuration tool; creating project-specific libraries of logical node types for the user-programmable control device using an editing program which is implemented as a logical node type editor; selecting previously created project-specific libraries using a controller configuration tool; and producing device-specific configuration descriptions (ICD) for the control or automation system, which form a firmly prescribed set of logical node types for the control or automation system and which are provided for further processing.

An arrangement is disclosed for configuring a user-programmable control device for integration of an intelligent field device into a control or automation system having a flexibly expandable hardware structure which comprises: a device configuration tool for providing a configuration description file which defines data interchange from the device configuration tool to an electrical field device in accordance with a defined communications protocol; a system configuration tool for storing a system specification description, which defines data interchange from the system configuration tool to the device configuration tool in accordance with a defined communications protocol, wherein the device configuration tool is configured for producing device configuration data from a configuration device description and a system configuration description provided by the system configuration tool; an editing program, which is implemented as a logical node type editor, for creating project-specific libraries of logical node types for the user-programmable control device; and a controller configuration tool for selecting previously created project-specific libraries, and for producing device-specific configuration descriptions for the control or automation system, which correspond to a firmly prescribed set of logical node types for the control or automation system and which are available for further processing.

### BRIEF DESCRIPTION OF THE DRAWINGS

The disclosure is explained below with reference to the exemplary embodiments shown in the drawings. In the drawings:

FIG. 1 shows an exemplary IEC 61850 configuration for the integration of intelligent field devices having a fixed structure according to known configuration tools,

FIG. 2 shows an exemplary arrangement for configuring a user-programmable control device having a flexible field device structure, for example, a flexibly expandable hardware structure;

FIG. 3 shows an exemplary procedure for transmitting the created device-specific configuration descriptions; and

FIG. 4 shows, by way of example, a logical node type editor for producing project-specific libraries for the communications nodes.

### DETAILED DESCRIPTION

This disclosure provides a method and an arrangement for performing a method for configuring a user-programmable control device for the integration of intelligent field devices into a control or automation system, and the integration of devices from different manufacturers into the control or automation system with acceptable outlay.

For example, a method for configuring a user-programmable control device for the integration of intelligent field devices into a control or automation system is disclosed, wherein the configuration of the control or automation system is created by means of a device configuration tool and a system configuration tool. The system configuration tool is used to store a system specification description (SSD), which defines the data interchange from the system configuration tool to the device configuration tool in accordance with a defined communications protocol. A configuration device description (CID), which defines the data interchange from the device configuration tool to the device (IED) in accordance with a defined communications protocol, is provided for the device configuration tool, and device configuration data are produced in the device configuration tool from the provided configuration device description (CID) and the system configuration description (SCD) provided by the system configuration tool. Project-specific libraries of the logical node types for the user-programmable controller are created by means of an editing program, which is implemented as a logical node type editor. A controller configuration tool is used to make a selection for the previously created library, and which is used to produce the device-specific configuration descriptions (ICD) provided for the control or automation system, which form a firmly prescribed set of logical node types for the control or automation system and which are provided for further processing.

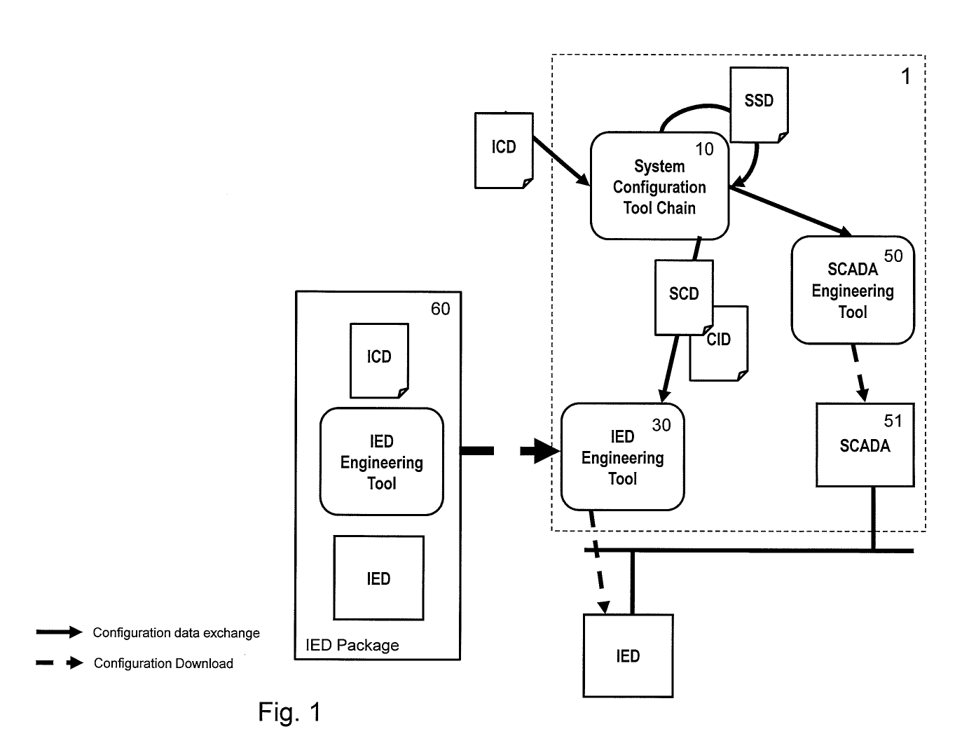

FIG. 1 shows an exemplary standard configuration tool 1, which operates in accordance with the IEC 61850 standard, for the integration of intelligent field devices IED having a previously defined structure according to known configuration tools. Before a control system is operational, the hardware IED provided therefor in the engineering tool 1 for configuring the devices provided in the system is mapped as part of a PLC or control project, wherein, among other things, information about input/output addresses of the intelligent field devices IED is stored in the control project and made accessible to a user program.

The method according to the present disclosure connects intelligent electrical devices (IEDs) to a user-programmable control device, wherein a flexibly expandable hardware structure is assumed and, in addition, newly produced device descriptions which are adapted to the respective application of the control or automation system are provided.

The newly produced application-specific or project-specific device descriptions as disclosed, allows new devices from a wide variety of device manufacturers to be incorporated into the control or automation system with comparably low outlay in terms of configuration.

The configuration of the control or automation system is created in this case by means of a device configuration tool (IED configurator) and a system configuration tool (system configurator). For this purpose, the system configuration tool is used to store a system specification description, which defines the data interchange from the system configuration tool to the device configuration tool in accordance with a previously defined communications protocol. Device configuration files are produced in the device configuration tool from a provided configuration description file (CID) and the system configuration description (SCD) provided by the system configuration tool and are transmitted from the device configuration tool to the IED devices in accordance with the previously defined communications protocol.

According to the disclosure, project-specific libraries, which contain the relevant information for different areas of application or application profiles, of the communications nodes needed for the user-programmable controller for the purpose of mapping the data to be communicated for the devices, also called logical node types, are created by means of an editing program which is implemented as a logical node type editor.

A controller configuration tool is used to make a selection from these for the previously created library for the actual installation configuration. By means of the selected library, the device-specific configuration descriptions ICD provided for the control or automation system, which form a firmly prescribed set of logical node types for the control or automation system and which are provided for further processing, are produced in the controller configuration tool.

For example, the data interchange from the device configuration tool to the device and from the system configuration tool to the device configuration tool is performed in accordance with the IEC 61850 standard.

The logical node types produced by means of the logical node type editor are processed further as though the controller contained a firmly prescribed set of logical node types, and the standard tools, in accordance with the IEC 61850 standard can be used in order to configure the IEC 61850-compliant communication in the system.

In accordance with an exemplary method according to the present disclosure, for the purpose of producing device-specific configuration descriptions ICD for a user-programmable control device having a flexible field device structure, the application profiles and options are stored in logical node types in the system configuration using an upstream level, subsequently also designated as flexible configuration tool, and a flexible device is thereby incorporated into an existing system configuration tool landscape, also designated as standard configuration tool, which recognizes and supports only intelligent field devices having a previously defined fixed structure.

For example, the flexible configuration tool has a flexible device type and a logical node type library, whereas the standard configuration tool recognizes and supports only one fixed device type.

The device-specific configuration descriptions produced by the flexible configuration tool can be transmitted to the standard configuration tool and processed further with the substation configuration description stored therein in order to map the device type adapted to the application profile with options to the project-specific instance.

An arrangement for performing the method described above can include a device configuration tool (30) and a system configuration tool (10) for creating the configuration of the control or automation system. The system configuration tool (10) stores a system specification description (SSD), which defines the data interchange from the system configuration tool (10) to the device configuration tool (30) in accordance with a defined communications protocol, the device configuration tool (30) provides a configuration description file (CID), which defines the data interchange from the device configuration tool (30) to the device (IED) in accordance with a defined communications protocol. The device configuration tool (30) produces device configuration data from the provided configuration device description (CID) and the system configuration description (SCD) provided by the system configuration tool (10), wherein an editing program (61), which is implemented as a logical node type editor (61), creates project-specific libraries (64) of the logical node types which are needed for the user-programmable controller. A controller configuration tool (62) makes a selection for the previously created library (64), and which is used to produce the device-specific configuration descriptions (ICD) provided for the control or automation system, which correspond to a firmly prescribed set of logical node types for the control or automation system and which are available for further processing.

An exemplary arrangement for configuring a user-programmable control device for the integration of intelligent field devices into a control or automation system having a flexibly expandable hardware structure comprises a device configuration tool (IED configurator) and a system configuration tool (system configurator) for creating the configuration of the control or automation system. For example, the system configuration tool stores a system specification description, which defines the data interchange from the system configuration tool to the device configuration tool in accordance with a defined communications protocol.

The device configuration tool stores a configuration description file (CID), which defines the data interchange from the device configuration tool to the device in accordance with a defined communications protocol.

The arrangement according to the present disclosure can comprise an editing program, which is implemented as a logical node type editor and which creates project-specific libraries of the communications nodes for the user-programmable controller for the purpose of mapping the data to be communicated for the devices, also called logical node types, and a controller configuration tool which makes a selection for a previously created library. The controller configuration tool is used to make a selection from these for the previously created library according to the application profile, and this is used to produce the device-specific configuration descriptions (ICD) provided for the control or automation system, which correspond to a firmly prescribed set of logical node types for the control or automation system and which are available for further processing.

The exemplary embodiments and improvements of the disclosure will be explained and described in more detail on the basis of the exemplary embodiments illustrated in the figures which follow.

The data interchange from the engineering tool 1 to the devices of the control or automation system is performed in accordance with IEC standard 61850 and is described in IEC 61850-6. FIG. 1 shows the configuration description files system specification description SSD, substation configuration description SCD, IED capability description ICD and configured IED description CID, and also the interchange of the shown configuration data according to the known systems. This is explained further in the text which follows.

The two standard configuration tools IED configurator 30 and system configurator 10 are available for the configuration. The configuration of the control system is created by means of the IED configurator 30 and the system configurator 10 in accordance with the IEC 61850 standard.

For example, a system specification description SSD, which defines the data interchange from the system configurator 10 to the IED configurator 30 in accordance with the IEC 61850 standard, is stored in the system configurator 10.

Device configuration files, which are provided for transmission to the IEC 61850 standard-communications modules of the devices IED by means of a configuration download, are produced in the IED configurator 30 from a provided IED configuration description (CID) and the system configuration description (SCD) provided by the system configurator 10.

At the start of the project, the device descriptions 60 for the IED devices, which can be included with the relevant field devices IED on a storage medium by the device manufacturers as a program, are transmitted to the IED configurator 30 and, together with the IED capability description ICD stored in the system configurator 10, a configuration is created for each device IED provided in the system. The device-specific substation configuration descriptions SCD thus created, which contain the respective configuration of the devices provided in the control system, are then transmitted via the IED configurator 30 to the devices in the control system.

In an exemplary embodiment, further IEC 61850 projects having corresponding interfaces to the control project, such as a data acquisition and data monitoring system (SCADA) 50 having a SCADA engineering tool, may also have been incorporated into the overall system.

In accordance with the method according to the present disclosure, which is shown in the figures which follow, instead of using firmly prescribed devices which are mapped according to a particular application profile, the application profiles and options are stored in logical node types in the system configuration using an upstream level 2, and a flexible device is thereby incorporated into an existing system configuration tool landscape as shown in FIG. 1, which recognizes and supports only fixed devices.

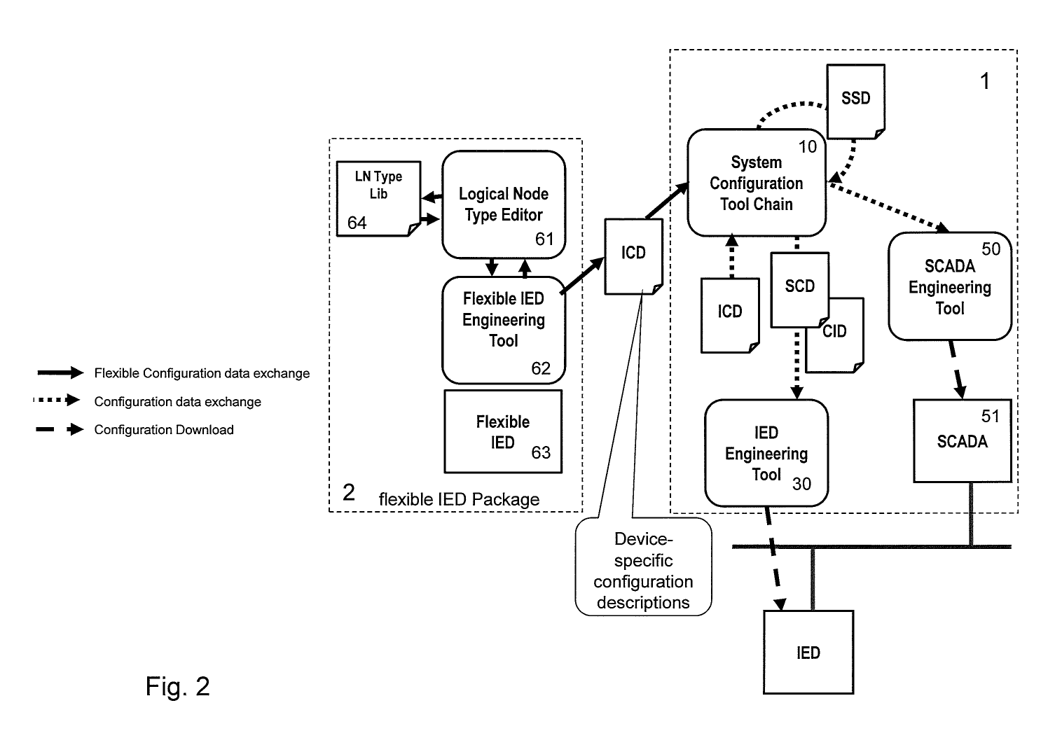

FIG. 2 shows, by way of example, an arrangement 2, also called flexible configuration tool, placed to the left of the standard configuration tool 1, which operates in accordance with the IEC 61850 standard, for the integration of intelligent field devices having a fixed structure, as described in FIG. 1, for producing device-specific configuration descriptions ICD for a user-programmable control device having a flexible field-device structure in accordance with the method according to the wherein. The data interchange of the flexible configuration is denoted by means of solid arrows.

The arrangement 2 shown in FIG. 2 shows the flexible configuration tools logical node type editor 61 for adapting to the application profiles and the optional parts contained therein and controller configuration tool 62 for creating device-specific configuration descriptions ICD, which tools are provided according to the wherein. For this purpose, the logical node type editor 61 interchanges configuration data with a logical node type library 64, in which are stored application-specific or project-specific function blocks for different areas of application of the user-programmable controllers for different applications, and with the controller configuration tool 62. This will be explained in more detail below.

The controller configuration tool 62, also designated as flexible IED engineering tool, uses the logical node type editor 61 to produce the project-specific logical node type libraries 64, from which, depending on the intelligent devices IED used, a configuration description ICD is produced for each device provided in the system. This configuration description is subsequently also called device-specific configuration descriptions.

The device-specific configuration descriptions ICD produced provide a firmly prescribed set of logical node types for the user-programmable controller of the control or automation system, which are provided for transmission to the IEC 61850-standard communications modules of the devices 63 selected on a project-specific basis, by means of a configuration download.

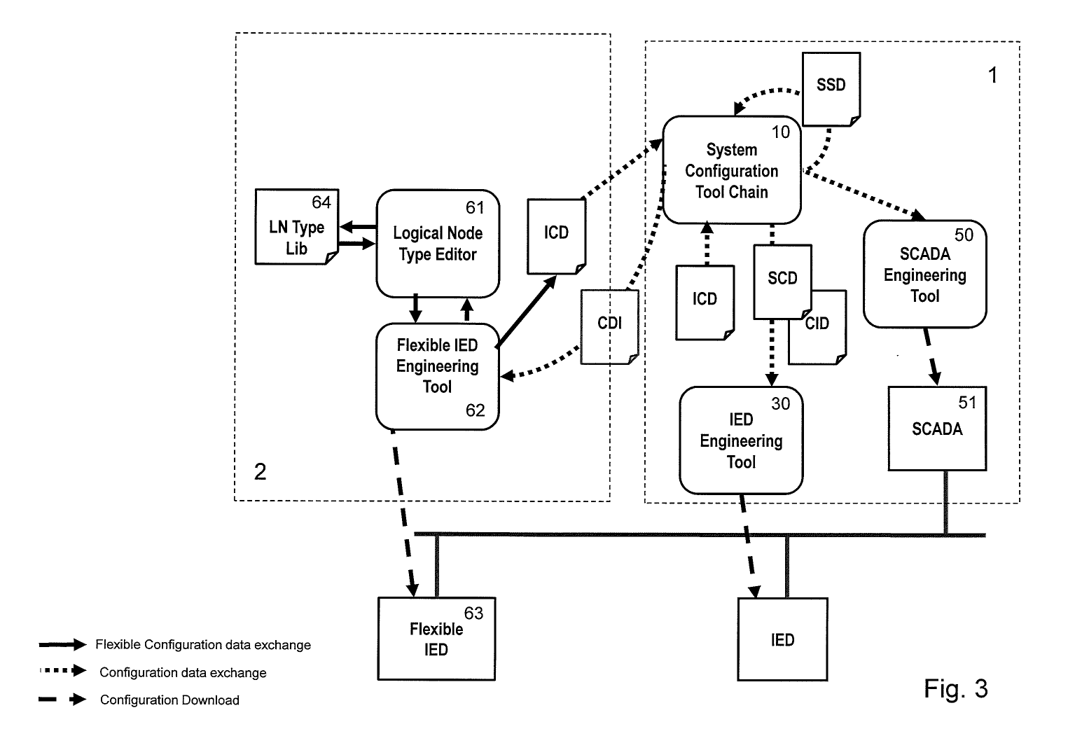

FIG. 3 shows an exemplary procedure for transmitting the device-specific configuration descriptions ICD, created in the controller configuration tool 62 by means of the logical node type editor 61 and the project-specific libraries 64, in accordance with the respectively provided application for the control or automation system.

Like the device descriptions 60 for the IED devices, which are included with field devices on a storage medium by the device manufacturers as a program, the device-specific configuration descriptions ICD produced are transmitted to the standard configuration tool and are processed further in the system configurator 10 with the substation configuration description SCD stored therein in order to map the device type adapted to the application profile with options to the project-specific instance, subsequently designated as CDI. The CDI are then once more provided for the controller configuration tool 62 of the flexible configuration tool 2 and transmitted to the communications modules of the flexible devices 63 by means of a configuration download.

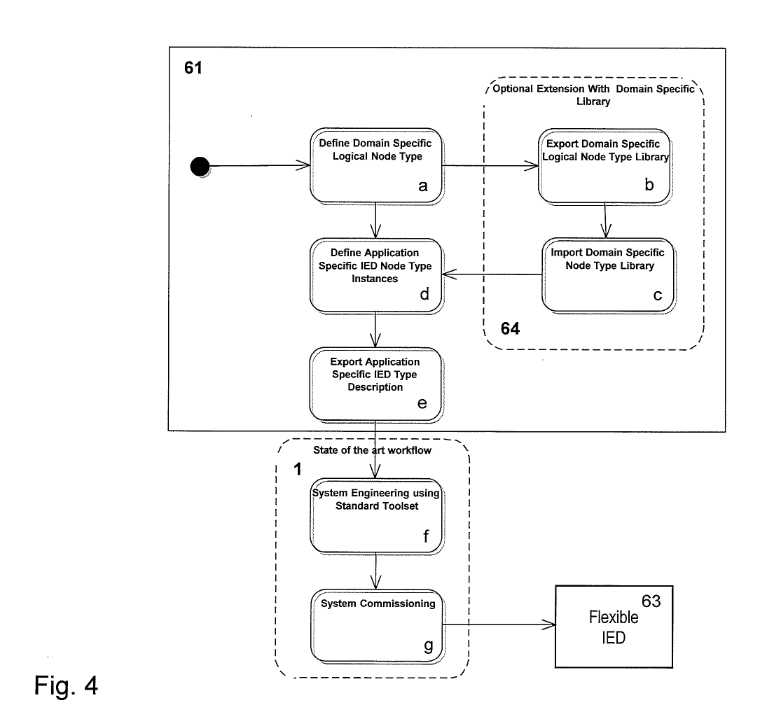

FIG. 4 shows, by way of example, a logical node type editor 61 for producing project-specific libraries 64 which contain the relevant device-specific information for different applications or control projects.

After logical node types have been defined in the logical node type editor 61 in a first step a according to the desired application profile with the desired options, the installation-type-specific logical node type library 64 is produced therefrom in a second step b and is imported back into the logical node type editor 61 in a third step c so as, in a further step d, to form application-specific or project-specific IED node type instances therefrom with the previously defined application-profile-specific logical node types.

In a subsequent step e, the application-specific IED node type instances are prepared as an IED type description of fixed structure for the standard configuration tool 1. In step f, the IED type description of fixed structure are transmitted to the standard configuration tool 1, and, in a final step g, the IED type description of fixed structure are provided for transfer to the control system.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for configuring a user-programmable control device for integration of an intelligent electrical field device into a control or automation system having a flexibly expandable hardware structure, comprising:
storing a system specification description on a system configuration tool, wherein the system specification description defines a data interchange from the system configuration tool to a device configuration tool in accordance with a defined communications protocol;
providing a configuration device description, which defines the data interchange from the device configuration tool to an intelligent electrical field device in accordance with a defined communications protocol for the device configuration tool;
producing device configuration data in the device configuration tool from the configuration device description and a system configuration description provided by the system configuration tool;
creating project-specific libraries of logical node types for the user-programmable control device using an editing program which is implemented as a logical node type editor;
selecting a previously created library using a controller configuration tool; and
producing a device-specific configuration descriptions for the control or automation system, which form a prescribed set of logical node types for the control or automation system and which are provided for further processing.

2. The method according to claim 1, wherein the data interchange from the device configuration tool to the electrical field device and from the system configuration tool to the device configuration tool is performed in accordance with an IEC 61850 standard.

3. A method for configuring a user-programmable control device for integration of an intelligent electrical field device (IED) into a control or automation system having a flexibly expandable hardware structure, comprising:
creating a configuration of the control or automation system using a device configuration tool and a system configuration tool;
storing a system specification description (SSD) on the system configuration tool, which defines the data interchange from the system configuration tool to the device configuration tool in accordance with a defined communications protocol;
providing a configuration device description (CID) for the device configuration tool, which defines data interchange from the device configuration tool to an electrical field device (IED) in accordance with a defined communications protocol;
producing device configuration data in the device configuration tool from the configuration device description (CID) and a system configuration description (SCD) provided by the system configuration tool;
creating project-specific libraries of logical node types for the user-programmable control device using an editing program which is implemented as a logical node type editor;
selecting previously created project-specific libraries using a controller configuration tool; and
producing device-specific configuration descriptions (ICD) for the control or automation system, which form a firmly prescribed set of logical node types for the control or automation system and which are provided for further processing.

4. The method according to claim 1, wherein the data interchange from the device configuration tool to the electrical field device and from the system configuration tool to the device configuration tool is performed in accordance with an IEC 61850 standard.

5. An arrangement for configuring a user-programmable control device for integration of an intelligent field device into a control or automation system having a flexibly expandable hardware structure comprising:
a device configuration tool for providing a configuration description file which defines data interchange from the device configuration tool to an electrical field device in accordance with a defined communications protocol;
a system configuration tool for storing a system specification description, which defines data interchange from the system configuration tool to the device configuration tool in accordance with a defined communications protocol, wherein the device configuration tool is configured for producing device configuration data from a configuration device description and a system configuration description provided by the system configuration tool;
an editing program, which is implemented as a logical node type editor, for creating project-specific libraries of logical node types for the user-programmable control device; and
a controller configuration tool for selecting previously created project-specific libraries, and for producing device-specific configuration descriptions for the control or automation system, which correspond to a firmly prescribed set of logical node types for the control or automation system and which are available for further processing.

6. The arrangement according to claim 3, wherein the data interchange from the device configuration tool to the electrical field device and from the system configuration tool to the device configuration tool is performed in accordance with an IEC 61850 standard.
